(19) United States
(12) Patent Application Publication
(10) Pub. No.: US 2015/0148100 A1
(43) Pub. Date: May 28, 2015

(54) INTERCOM HANDSET FOR CELLULAR PHONES AND SMARTPHONES WITH E.M.F. SHIELD

(71) Applicant: MANARIN SRL, Mogliano Veneto (TV) (IT)

(72) Inventor: Franco Malenotti, Mogliano Veneto (TV) (IT)

(73) Assignee: MANARIN SRL, Mogliano Veneto (TV) (IT)

(21) Appl. No.: 14/394,195

(22) PCT Filed: Mar. 25, 2013
(86) PCT No.: PCT/IB2013/000479

§ 371 Date: Oct. 13, 2014

(30) Foreign Application Priority Data
Apr. 12, 2012 (IT) TV2012A000057

(51) Int. Cl. H04B 1/3827; H04B 1/3883; H04M 1/02; H04M 1/15; H04M 1/725

(52) U.S. Cl. CPC H04B 1/3838; H04M 1/15; H04M 1/7253; H04M 1/0254; H04M 1/7258; H04B 1/3883
USPC 455/557

(57) ABSTRACT

Intercom handset for cellular phones and smartphones provided with a ferritic layer of shielding against the electromagnetic field or E.M.F. emitted by mobile phone devices. The intercom handset can be rapidly inserted onto the cellular phone and used directly connected to the latter by means of an extensible and retractable cable, contained inside its body, or by means of a Bluetooth connection. The intercom handset can also be used separated from the phone, by means of said extensible and retractable cable, contained inside its body, or by means of a wireless connection by means of the built-in Bluetooth module, whose battery is charged by means of an inductive load system that charges the battery of the built-in Bluetooth module, using the radio transmission energy of the cellular phone or smartphone, normally dispersed in the air during the periodic search for the cellular transmission network and during the telephone conversation.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention relates to an intercom handset for cellular phones or smartphones made of a composite plastic material, provided with a ferritic layer of shielding against the electromagnetic field or E.M.F. emitted by mobile phone devices. The intercom handset can be rapidly inserted on the phone itself and used directly connected to the latter by means of an extensible and retractable cable contained inside its body, or by means of a Bluetooth connection. The intercom handset can also be used separated from the phone, by means of said extensible and retractable cable contained inside its body, or by means of a wireless connection by means of the built-in Bluetooth module.

2. Description of Related Art Including Information Disclosed Under 37 CFR 1.97 and 37 CFR 1.98.

Nowadays, the difficulty of use of cable intercoms is known. It is very difficult to carry them and their use is made difficult by the presence of the cables and of small elements without any support such as speakers and microphone. Even the intercoms with Bluetooth technology have not become established. They are fragile, easy to lose, it is necessary to always carry them on one's ear, besides needing periodic charging of the batteries they contain.

Known are also the cable intercoms equipped with a retractable mechanism that, therefore, are of even smaller sizes and, so, one easily loses them as well.

The danger for brain health of the electromagnetic waves emitted by cellular phones and smartphones, especially for big users and for youths, is also known, also due to the fact that it has been the subject of recent studies. In fact, it has been demonstrated that the E.M.F. waves emitted by smartphones and by cellular phones in general can damage the brain mass by heating it.

At present there is the considerable recourse to solutions in the sector, sometimes original but not exhaustive and economical, this because they do not aim at resorting to an intercom system that first of all acts as a shield against the electromagnetic waves emitted by cellular phones and that is of a size that makes it easy to localize.

Known are also the potentially harmful effects of the Bluetooth intercoms that communicate at frequencies equal to those of the common microwave ovens, which in the case of this heating are aimed at obtaining the maximum effect on the water molecules. In practice, using a Bluetooth intercom is equivalent to inserting into the ear a microwave source having a frequency equal to that of ovens, although having minimum power.

It is also known that Bluetooth intercoms are miniaturized and, therefore, easy to lose or to be found flat when one needs them because they are powered by internal rechargeable batteries. There are also cellular phones that incorporate a Bluetooth intercom such as the Van Gogh from the Chinese NGM or a model from LG Electronics, a new solution that provides the insertion of a wireless earphone and microphone into the body of an LG mobile phone. In practice the earphone and microphone would be perfectly integrated in the body of the LG mobile phone, with the possibility, however, to be removed, acting as a wireless earphone.

Therefore, one can reasonably state that certainly nowadays the difficulty of use of cable interphones is known, which are difficult to carry and their use is made difficult by the presence of the cables and of small elements. Known are also the cable intercoms equipped with a retractable mechanism that, therefore, are of even smaller sizes and, so, one easily loses them as well. The danger for brain health of the electromagnetic waves emitted by cellular phones and smartphones, as they damage the brain mass, especially for big users and for youths, is also known, also due to the fact that it has been the subject of recent studies. Furthermore, the fragility of the intercoms with the Bluetooth technology is also known, one easily loses them, it is necessary to always carry them on one's ear, besides needing periodic charging of the batteries they contain, and are a source of direct radiation of microwaves to the brain by means of the auricle. Known is also the presence of cellular phones that incorporate a Bluetooth intercom providing the insertion of a wireless earphone and microphone into the body of a mobile phone, with the possibility to be removed, to act as a wireless earphone or intercom.

Prior Art

A search has been made in the field of intercom devices for cellular phones and smartphones, removable, equipped with a retractable and non-retractable cable, wireless and non-wireless, which, although not in depth, has allowed to find at least the following prior documents:

| D1 | US20031 | | 65237 | (A1) | FARR ALEXANDER |
|---|---|---|---|---|---|
| D2 | US201 | 1 | 233078 | (A1) | MONACO DEAN |

| D3 | US2008080732 | | (A1) | SNEED BRIAN |
|---|---|---|---|---|
| D4 | WOO1 | 78487 | (A2) | LU XUN COMMAT |
| D5 | US20042041 | 65 | (A1) | HUANG MANQING |

| | | | |
|---|---|---|---|
| D6 | US2003224839 | (A1) | TAKAHASHI TSUTOMU |

D1 represents an intercom device that is built in a portable electronic device such as a cellular phone, or portable digital assistant. The headset is made with an earphone for the reception of sound, and a microphone for the transmission of sound. In the electronic device there is a recess for housing the receiver and microphone, and a locking device for fastening the earphone and the microphone in the electronic device when not in use. The intercom is also provided with a retractable cable for extending the earphone and the microphone from the device held in one's hand to position the earphone in the auditory canal. In another embodiment of the present invention the earphone and microphone can work in a wireless transmitter, eliminating the need for the winding mechanism.

D2 represents supports for supporting portable electronic hand-held devices, such as, but not only, iPhone™, iPOD™, iPad™, cellular phones and the like. An embodiment has an upper space on a back plate with the outline edges that allow a retractable cable and headphones (earphones, headphones) to be both contained inside it when not in use. A winding mechanism of the spring-loaded type on the panel with outline edges automatically retracts both the cable and the headphones into the space where a hinge cover hides and protects both the cable and the headphones when not in use. The back plate with the outline edges can include an inwardly protruding internal male plug that is connected to the cable so that, by sliding the electronic portable device in the outline edges, the plug is inserted into a female socket on the electronic portable device and, by sliding the device outwards, the socket is removed from the male plug. Another embodiment has a portable support for an electronic hand-held device with a built-in bottle opener, where the bottle opener is in the external face of a box-shaped element slightly raised on the upper back part of the container.

D3 represents a transport system of an electronic device having a retractable headphone assembly. The transport system suitable to support an electronic device and to be attached to a user or to their garments. A first plug configured to communicate with the electronic device is connected to a second plug on the front end of the housing, said plugs being connected by a connector cable secured to the housing. A user-controlled spring-operated spool secured to the housing is suitable to extend and retract a transducer assembly having at least one transducer and a headphone cable. One or more conductive brackets are mounted inside an opening formed in the spool, the spool being configured to rotate around said second plug. The conductive brackets, each having a plurality of contact surfaces, electrically couple the transducer assembly to the second plug in a secure manner.

D4 represents a cellular, vertical speaker and microphone structure in which the speaker and microphone are mounted vertically on the side of the phone rather than in the forepart as at present. The speaker or microphone can be fixed or retractable, being able to be retracted manually or with a click when the release button is pushed. With this configuration, the distance between the antenna and the human face is greater, in such a way that many of the problems existing in the current structure, such as SAR and GSM buzz, can be improved. This can also make the phone smaller. An arrangement of a speaker and a microphone of a mobile phone is revealed, in which the speaker and the microphone are located on one side of the phone body. The microphone and the speaker can be supported in a fixed or extracted position, providing the best miniaturization of the phone and improved sound properties, as well as the reduction of the exposure of the head of the user of the mobile phone to the radiation of radio waves emitted by the antenna because of the greater distance from the antenna.

D5 represents an electronic portable device with cellular phone functions that is equipped with a built-in free-hand earphone-microphone. A transport device for an electronic portable device with cellular phone functions is equipped with a built-in or connected free-hand earphone-microphone. The earphone-microphone is retractable, and is replaced in the electronic portable device or in the transport device with an access point accessible from outside during the periods of non-use, and it can be extracted for a telephone conversation. This earphone is equipped with a cable winding mechanism that acts as an internal storage for the cable. The cellular phone or the transport device provides the availability of a freehand earphone-microphone and the convenience of carrying the earphone-microphone, therefore it facilitates the use of the earphone-microphone having one's hands free when appropriate.

D6 represents a mobile communication device with an earphone kit, wherein the earphone is an integral part of the mobile communication device or an integral part of an accessory device able to transfer signals between the earphone and the mobile communication device, and wherein the earphone is connected to the cover of the respective device, where a retractable means is provided to activate at least the retraction of the cable of the headphone into the cover. Moreover, an operational state of the mobile communication device is controlled by the state of retraction of the headphone.

In conclusion it is reasonable to consider as known:
a) an intercom device that is built in a portable electronic device such as a cellular phone, or portable digital assistant; in the electronic device there is a recess for replacing the receiver and microphone, and a locking device for fastening the earphone and the microphone in the electronic device when not in use;
b) a winding mechanism provided with a retractable cable for extending and retracting the earphone and the microphone from the device held in one's hand to position the earphone in the auditory canal; an earphone and a microphone that can work by means of a wireless transmitter, eliminating the need for the winding mechanism;
c) a rewinding mechanism of the spring-loaded type on a panel with outline edges that automatically retracts both the cable and the headphones into the space where a cover hides and protects both the cable and the headphones when not in use; the back panel with the outline edges can include an inwardly protruding internal male plug that is connected to the cable in such a way that, by sliding the electronic portable device in the outline edges, the plug can be inserted into a female socket on the device;
d) a speaker or microphone, which can be fixed or retractable and that can be retracted manually or with a click when a release button is pushed;
e) a microphone and speaker, which can be supported in a fixed or extracted position, providing the reduction of the exposure of the head of the user of the mobile phone to the radiation of radio waves emitted by the antenna because of the greater distance from the antenna;
f) a mobile communication device with an earphone kit, wherein the earphone is an integral part of the mobile communication device or an integral part of an accessory device able to transfer signals between the earphone and the mobile communication device, and wherein the earphone is connected to the cover of the respective device, where a retractable means is provided to activate at least the retraction of the cable of the headphone into the cover; with the operational state of the mobile communication device controlled by the state of retraction of the earphone kit.

Drawbacks

Considering what has been stated above and what is of public domain, we would like to point out that the intercom devices for cellular telephones and smartphones, removable, equipped with a retractable and non-retractable cable, wireless and non-wireless, do not concern an intercom provided with a shield against the electromagnetic field or E.M.F., emitted by mobile phone devices and easily transportable and applicable to the smartphone or cellular phone, usable either applied to the latter, or removing it from the smartphone or cellular phone to use it as a real handset; wherein all the components are part of the same intercom device with the connection wire contained inside this handset element that, by means of a spring apparatus, makes it automatically extractable and windable inside said element.

As it is public domain, we also point out that the intercom devices with Bluetooth technology for cellular phones and smartphones are not provided with a shield of the electromagnetic field or E.M.F. emitted towards the user's ear and need periodic charging of the batteries they contain. Although often resorting to similar solutions in the sector, they are to be considered not exhaustive and economical, this because, in principle, they do not yet aim at resorting to an intercom system that first of all acts as a shield against the electromagnetic waves emitted by cellular phones and is of a size that makes it easy to locate.

On the other hand, as for a specifically designed combination of intercom devices for cellular phones and smartphones, removable, equipped with a retractable and non-retractable cable, wireless and non-wireless, provided with a shield against the electromagnetic field or E.M.F., emitted by mobile phone devices and easily transportable and applicable to the smartphone or cellular phone, usable either applied to the latter, or removing it from the smartphone or cellular phone to use it as a real handset and furthermore provided with an inductive load system that charges the battery of the built-in Bluetooth module, using the radio transmission energy of the cellular phone or smartphone, normally dispersed in the air, similar embodiments or embodiments that suggest its use in patents and in general are not to be found in the prior art. Basically, it can therefore be stated that what has been found in the prior art relates to the use of traditional intercoms, employing earphones and microphones by means of retractable cables or Bluetooth modules, both not shielded against the electromagnetic field or E.M.F. emitted by mobile phone devices.

Considering what has been mentioned above, there is the need for companies, particularly of the sector, to find alternative solutions, more effective than the currently existing solutions. An aim of the present invention is also to avoid and solve the described drawbacks.

### BRIEF SUMMARY OF THE INVENTION

This and other aims are achieved by the present invention according to the characteristics as in the enclosed claims solving the mentioned problems by means of the realization of an intercom headset for cellular phones and smartphones provided with a ferritic layer of shielding against the electromagnetic field or E.M.F. emitted by mobile phone devices. Said intercom handset can be rapidly inserted onto the cellular phone and used directly connected to the latter by means of an extensible and retractable cable, contained inside its body, or by means of a Bluetooth connection. The intercom handset can also be used separated from the phone, by means of said extensible and retractable cable contained inside its body, or by means of a wireless connection by means of the built-in Bluetooth module, whose battery is charged by means of an inductive load system that charges the battery of said built-in Bluetooth module, using the radio transmission energy of the cellular phone or smartphone, normally dispersed in the air during the periodic search for the cellular transmission network and during the telephone conversation.

Aims and Advantages

In this way, by the considerable creative contribution the effect of which has allowed to obtain a considerable technical progress, some aims and advantages are achieved.

The first aim of the present invention was to allow the realization of an intercom handset for cellular phones and smartphones provided with a ferritic layer of shielding against the electromagnetic field or E.M.F. emitted by mobile phone devices, which consists of a ferritic layer of shielding built in the body of the intercom handset, on the side directed towards the user's head, and provided with holes of such a size that they allow only the output of the sound of the speaker and the input of the sound of the microphone. Therefore, it is possible to reasonably state that the amount of electromagnetic field or E.M.F. emitted towards the user's head by the mobile phone devices will be considerably reduced with respect to the conventional use of such devices.

A second aim was the realization of an intercom handset that can be rapidly inserted onto the cellular phone or smartphone and used directly connected to the latter, by means of an extensible and retractable cable contained inside its body, or by means of a connection by means of a Bluetooth module. This intercom handset is furthermore equipped with a call answer and end button.

A third aim consisted in realizing the intercom handset in such a way that it can also be used separated from the phone, by means of said extensible and retractable cable contained inside its body, or by means of a wireless connection by means of the built-in Bluetooth module.

A fourth aim consists of the realization of the intercom handset provided with a built-in Bluetooth module, whose battery is charged by means of an inductive load system that charges the battery of said built-in Bluetooth module, using the radio transmission energy of the cellular phone or smartphone, normally dispersed in the air during the periodic search for the cellular transmission network and during the telephone conversation.

These and other advantages will appear from the following detailed description of preferred embodiments with the aid of the enclosed schematic drawings, whose details of execution are not to be considered limitative but only illustrative.

### BRIEF DESCRIPTION OF THE DRAWINGS

FIGS. 1, 2, 3, 4 are three-dimensional views of the assembly parts of the intercom.

FIGS. 5, 6 are three-dimensional views of the intercom separated from the cellular phone or smartphone and connected by a wire or via Bluetooth.

### DETAILED DESCRIPTION OF THE INVENTION

### Practical Embodiment of the Invention

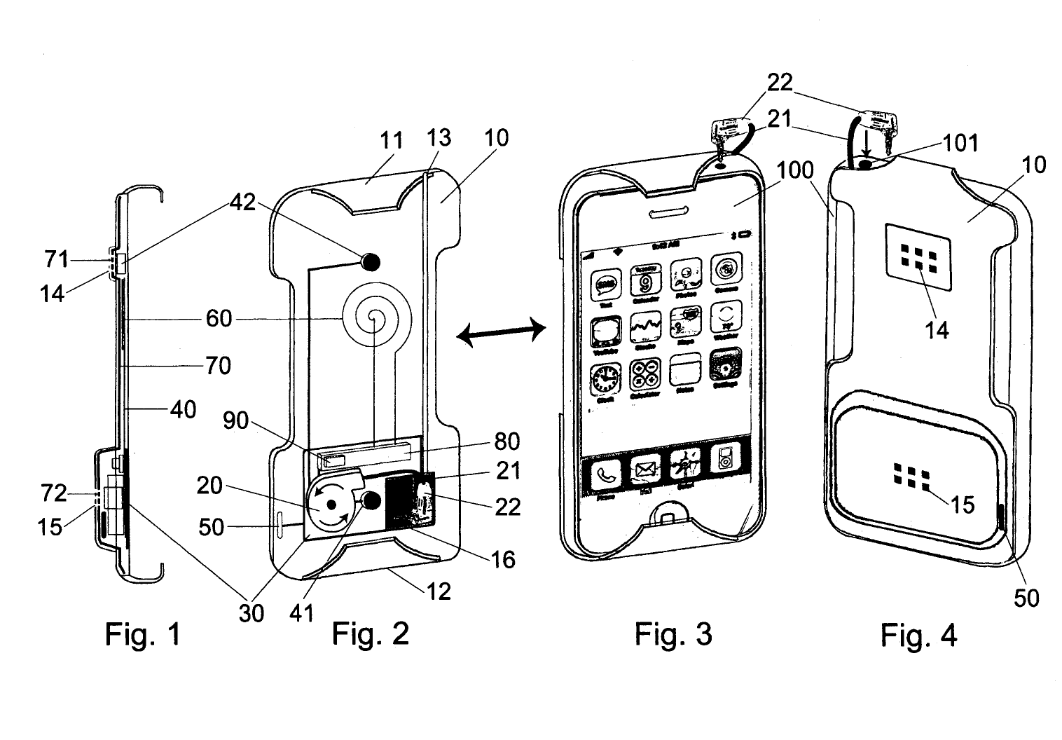

The object of the present invention (FIGS. 1, 2, 3, 4) is an intercom handset (10) for cellular phones or smartphones (100) made of a composite plastic material and provided with a ferritic layer of shielding (70) against the electromagnetic field or E.M.F. emitted by the cellular phone or smartphone (100), which intercom handset (10) is provided with a ferritic layer of shielding (70) built in the body of the intercom handset (10), on the side directed towards the user's head, and provided with holes (71, 72) of such a size that they allow only the output of the sound of the speaker (42) and the input of the sound of the microphone (41), and through the corresponding holes (14, 15) obtained respectively in correspondence in the external body of the intercom handset.

Realization of an intercom handset (10) that can be rapidly inserted joined in a removable way to the cellular phone or smartphone (100), containing it by means of a containment shaped upper part (11) of the cellular phone or smartphone (100) and a containment shaped lower part (12) of the cellular phone or smartphone (100) and used directly connected to the latter, by means of an extensible and retractable shielded cable for speaker, microphone and answer (21), contained inside the body of said intercom handset (10) by means of a spring-loaded cable and plug extension and rewinding system (20) and extractable from a male plug housing for speaker, microphone and answer (16), then connectable to said cellular phone or smartphone (100) through the passage in a containment channel of the extensible cable (13), or by means of a Bluetooth module (80) connection. Said intercom handset (10) is furthermore equipped with a call answer and end button (50).

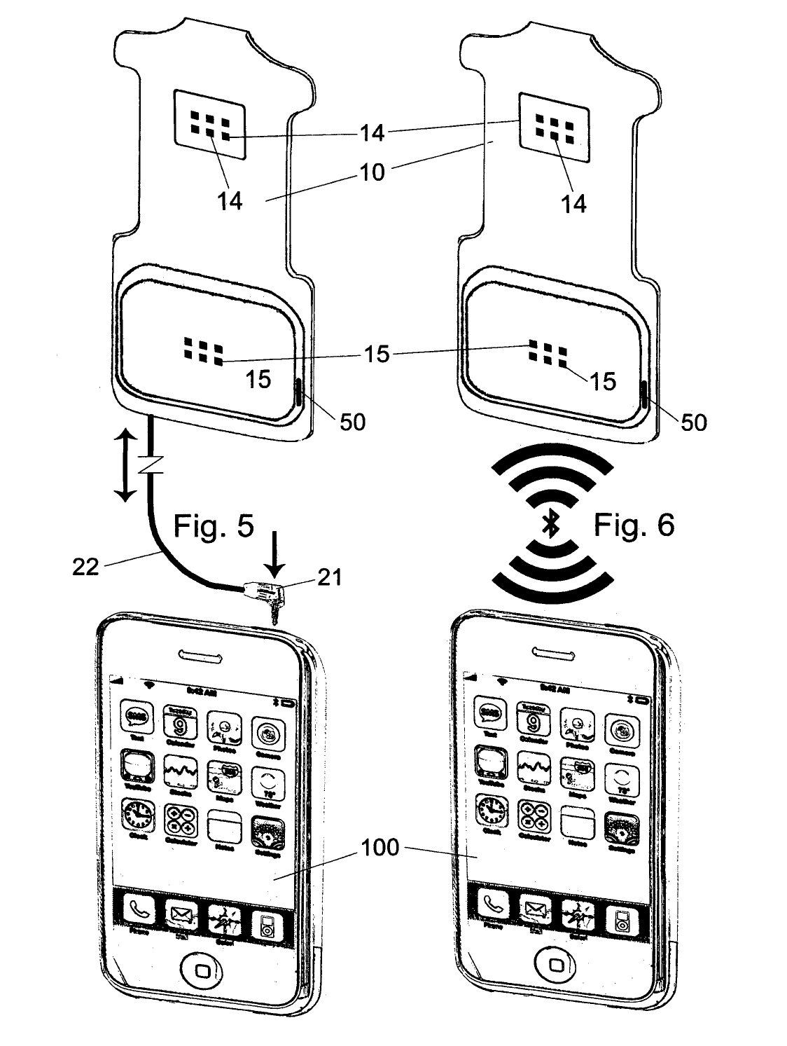

Furthermore, the intercom handset (10) can also be used separated from the cellular phone or smartphone (100) (FIGS. 5, 6), by means of said extensible and retractable shielded cable for speaker, microphone and answer (21), contained inside the body of said intercom handset (10) and connected by means of a male plug for speaker, microphone and answer (22) to the earphone and intercom handset socket (101) of the cellular phone or smartphone (100) (FIG. 5), or by means of a wireless connection by means of the Bluetooth module (80) built in the intercom handset (10) (FIG. 6). Said intercom handset (10) also in the above-mentioned ways of use is equipped with a call answer and end button (50).

Intercom handset (10) for cellular phones or smartphone (100) provided with a built-in Bluetooth module (80), whose rechargeable battery (90) is float charged by means of an inductive load system that charges said rechargeable battery (90) of the built-in Bluetooth module (80), receiving the radio transmission energy of the cellular phone or smartphone (100), normally dispersed in the air during the periodic search for the cellular transmission network and during the telephone conversation, by means of an inductive load coil (60) of the rechargeable battery (90) made on a thin film printed circuit or T.F.P.C.B. (40) that also supports all the other electrical and electronic parts of the intercom handset (10) and is built in it.

The embodiments represented in the drawings are purely illustrative and not exhaustive.

### REFERENCE

(10) intercom handset
(11) containment shaped upper part
(12) containment shaped lower part
(13) containment channel of the extensible cable
(14) speaker holes obtained in the external body of the intercom handset
(15) microphone holes obtained in the external body of the intercom handset
(16) male plug housing for speaker, microphone and answer
(20) spring-loaded system of cable and plug extension and rewinding
(21) extensible and retractable shielded cable for speaker, microphone and answer
(22) male plug for speaker, microphone and answer
(30) flap for accessing the internal components of the intercom handset
(40) thin film printed circuit or T.F.P.C.B.
(41) microphone
(42) speaker
(50) call answer and end button
(60) inductive load coil
(70) ferritic layer of shielding
(71) speaker holes obtained on the shielding layer of ferritic material
(72) microphone holes obtained on the shielding layer of ferritic material
(80) Bluetooth module
(90) rechargeable battery
(100) cellular phone or smartphone
(101) earphone and intercom handset socket

1. Intercom handset for cellular phones or smartphones made of a composite plastic material and provided with a ferritic layer of shielding against the electromagnetic field or E.M.F. emitted by the cellular phone or smartphone, characterised in that said intercom handset is provided with a ferritic layer of shielding built in the body of the intercom handset, on the side directed towards the user's head, and provided with holes of such a size that they allow only the output of the sound of the speaker and the input of the sound of the microphone.

2. Intercom handset for cellular phones or smartphones made of a composite plastic material according to claim 1, characterised in that it can be rapidly inserted joined in a removable way to the cellular phone or smartphone, containing it by means of a containment shaped upper part of the cellular phone or smartphone and a containment shaped lower part of the cellular phone or smartphone and used directly connected to said cellular phone or smartphone, by means of an extensible and retractable shielded cable for speaker, microphone and answer, contained inside the body of said intercom handset by means of a spring-loaded system of cable and plug extension and rewinding and extractable from a male plug housing for speaker, microphone and answer, then connectable to said cellular phone or smartphone through the passage in a containment channel of the extensible cable, or by means of a Bluetooth module connection, and wherein said intercom handset is also equipped with a call answer and end button.

3. Intercom handset for cellular phones or smartphones made of a composite plastic material according to claim 2, characterised in that it can also be used separated from the cellular phone or smartphone and is connected to it by means of said extensible and retractable shielded cable for speaker, microphone and answer, contained inside the body of said intercom handset and connected by means of a male plug for speaker, microphone and answer to the earphone and intercom handset socket of the cellular phone or smartphone, or by means of a wireless connection by means of the Bluetooth module built in the intercom handset, said intercom handset also in the above-mentioned ways of use being equipped with a call answer and end button.

4. Intercom handset for cellular phones or smartphones made of a composite plastic material according to claim 3, characterised in that it is provided with a built-in Bluetooth module, whose rechargeable battery is float charged by means of an inductive load system that charges said rechargeable battery of the built-in Bluetooth module, receiving the radio transmission energy of the cellular phone or smartphone, normally dispersed in the air during the periodic search for the cellular transmission network and during the telephone conversation, by means of an inductive load coil of the rechargeable battery, made on a thin film printed circuit or T.F.P.C.B. that also supports all the other electrical and electronic parts of the intercom handset and is built in it.

5. Cellular phone or smartphone with an intercom device, characterised in that said intercom device is an intercom handset also of the removable type with respect to said cellular phone or smartphone and is provided with a ferritic layer of shielding built in the body of the intercom handset, on the side directed towards the user's head, and provided with holes in such a way as to allow only the output of the sound of the speaker and the input of the sound of the microphone, said intercom handset being joined to the cellular phone or smartphone in such a way as to contain it by means of a containment shaped upper part of the cellular phone or smartphone and a containment shaped lower part of the cellular phone or smartphone and in such a way as to be used directly connected to said cellular phone or smartphone, by means of an extensible and retractable shielded cable for speaker, microphone and answer, contained inside the body of said intercom handset by means of a spring-loaded system of cable and plug extension and rewinding and extractable from a male plug housing for speaker, microphone and answer, connectable to said cellular phone or smartphone through the passage in a containment channel of the extensible cable, or by means of a Bluetooth module connection, and wherein said intercom handset is equipped with a call answer and end button.
